(19) United States
(12) Patent Application Publication
(10) Pub. No.: US 2003/0114155 A1
(43) Pub. Date: Jun. 19, 2003

(54) Method and system for GSM mobile station roaming to IS-41

(76) Inventors: Nikhil Jain, San Diego, CA (US); Gregory Heinzinger, Del Mar, CA (US)

Correspondence Address: QUALCOMM Incorporated, Attn: Patent Department, 5775 Morehouse Drive, San Diego, CA, 92121-1714, US

(21) Appl. No.: 10/077,556

(22) Filed: Feb. 14, 2002

Related U.S. Application Data
(60) Provisional application No. 60/340,356, filed on Dec. 14, 2001.

(51) Int. Cl. H04Q 7/20

(52) U.S. Cl. 455/432; 455/560; 455/426

(57) ABSTRACT

A roaming gateway interfaces between a CDMA MSC and a GSM core infrastructure, so that a GSM-enabled CDMA mobile station having a subscription in the GSM system can roam into the CDMA system and be authenticated to use the CDMA system. The roaming gateway obtains necessary authentication information from the GSM system and transfers the information to the mobile station using a short message service.

### CROSS-REFERENCE TO RELATED APPLICATION

This application claims priority from U.S. Provisional Patent Application Ser. No. 60/340,356, filed Dec. 14, 2001.

### FIELD OF THE INVENTION

The present invention relates generally to wireless communication systems, and more particularly to systems that permit GSM mobile stations to roam to CDMA areas.

### BACKGROUND

Code division multiple access (CDMA) is a digital wireless technology that inherently has relatively greater bandwidth capacity, i.e., that inherently permits the servicing of more telephone calls per frequency band, than other wireless communication technologies. Moreover, the spread spectrum principles of CDMA inherently provide secure communications. U.S. Pat. No. 4,901,307, incorporated herein by reference, sets forth details of a CDMA system, which can be used to transmit both voice calls and non-voice computer data.

Despite the advantages of CDMA, other wireless systems exist that use other principles. For example, in much of the world GSM is used, which employs a version of time division multiple access.

Whether CDMA principles or other wireless principles are used, wireless communication systems can be thought of as having two main components, namely, the wireless radio access network (RAN) and the core infrastructure which communicates with the RAN and with external systems, such as the public switched telephone network (PSTN), the Internet (particularly although not exclusively for data calls), etc. The core infrastructures associated with the various wireless technologies can be very expensive, both in terms of hardware and in terms of developing communication protocols to support particularized, typically system-specific call switching, subscription and attendant authentication and call monitoring, and billing. Consequently, the communication protocols of one wireless system (in the case of GSM, GSM protocols, and in the case of CDMA such as cdma2000-1x, IS-41 protocols) may not be compatible with those of another system without expensively prohibitive alterations in the core infrastructure of one system or the other.

From the disclosure above, the present invention recognizes that it would be desirable to enable the use of a CDMA-based RAN, with its attendant advantages, not only with a CDMA core infrastructure but also with a GSM-based core infrastructure, because GSM is extant in much of the world. The present invention still further recognizes, in light of the above, the desirability of minimizing if not eliminating the need to modify the communication protocols of the GSM core infrastructure.

Still further, the present invention recognizes that a dual-mode mobile station that advantageously interfaces with a CDMA RAN might be provided to use a GSM core infrastructure when in, e.g., Europe, and to use a CDMA infrastructure while in, e.g., the United States. Unfortunately, heretofore such a mobile station would require a subscription and telephone number in the GSM system and a separate subscription and telephone number in the CDMA system. This increases both complexity and cost from a user's standpoint. The present invention recognizes that it would be desirable to permit use of a dual-mode CDMA mobile station without requiring a subscription in both a CDMA core and a GSM core.

### SUMMARY OF THE INVENTION

A roaming gateway is configured for supporting communication between a CDMA mobile switching center (MSC) and a GSM core infrastructure to enable a mobile station (MS) subscribed in the GSM core infrastructure to communicate using the CDMA MSC. The roaming gateway may include a register communicating with the GSM core infrastructure and with the MSC to convey authentication information from the GSM core infrastructure to the MS and to signal to the MSC to provide service to the MS.

Preferably, the gateway includes an IS-41 home location register and a GSM visitor location register. Also, the roaming gateway can include a short message service center (SMSC). The SMSC sends the authentication information from the GSM core to the MS using a short message service (SMS).

In the preferred embodiment set forth below, the gateway receives a location message from the MS. The gateway uses an identifier in the location message to obtain the authentication information.

In another aspect, a method for authenticating an MS subscribing in a first wireless system and roaming into a second wireless system includes receiving location information from the MS. The method then includes determining whether the MS is subscribed in the first system or second system. If the MS is subscribed in the first system, it is registered in the second system.

In yet another aspect, a system for servicing, using an IS-41 MSC, a cdma2000-1x or cdma2000-3x MS having a subscription in a GSM core infrastructure but not having a subscription in a CDMA core infrastructure associated with the IS-41 MSC includes an IS-41 MSC and a CDMA RAN communicating with the IS-41 MSC. A roaming gateway communicates with the IS-41 MSC. Moreover, a GSM core infrastructure communicates with the roaming gateway.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present system for facilitating roaming between a GSM core infrastructure and a CDMA core infrastructure;

FIG. 2 is a flow chart of the logic of the present invention when a GSM-enabled CDMA MS roams into a CDMA area; and

FIG. 3 is a flow chart of the logic of the present invention when a GSM MS roams into a CDMA area.

### DETAILED DESCRIPTION OF THE PREFERRED EMBODIMENT

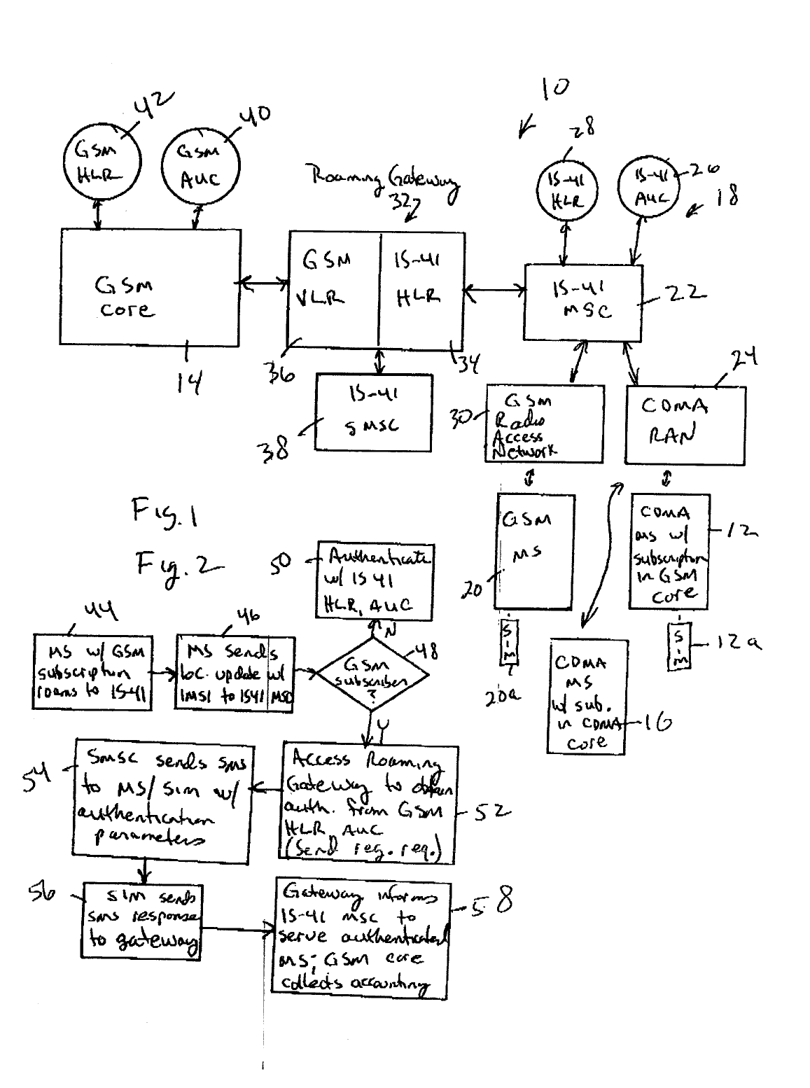

Referring initially to FIG. 1, a system is shown, generally designated 10, for establishing communication, including voice and computer data communication, for the following mobile stations (MS), all of which will be assumed to have roamed into a CDMA area such as the United States: a GSM-enabled dual mode CDMA MS 12 having a subscription in a GSM core infrastructure 14 and a conventional CDMA MS 16 with a subscription in CDMA core infrastructure 18. If desired the system 10 further can be used to support a conventional GSM MS 20 having a subscription in the GSM core infrastructure 14. The MS 12, 20, can have subscriptions only in the GSM core infrastructure 14 and need not have subscriptions in the IS-41 core infrastructure 18. The MS 12, 20 include respective subscriber identity modules (SIM) 12a, 20a that can be removably engaged with the MS 12, 20, respectively, in accordance with GSM principles known in the art.

The CDMA-based MS 12, 16 communicate with a CDMA, and more particularly an IS-41, mobile switching center (MSC) using a CDMA radio access network (RAN) 24 in accordance with CDMA principles known in the art. In accordance with CDMA principles known in the art, the CDMA RAN 24 includes base stations and base station controllers. The preferred CDMA RAN 24 shown in FIG. 1 uses cdma2000, and specifically uses either cdma2000 1x, cdma2000 3x, or cdma2000 high data rate (HDR) principles.

As shown in FIG. 1, the IS-41 core infrastructure 18 can include or can access an IS-41 authentication center 26 and an IS-41 home location register (HLR) 28 in accordance with IS-41 principles known in the art to authenticate subscriber mobile stations, e.g., the CDMA MS 16, and to collect accounting and billing information as required by the particular IS-41 core infrastructure 18.

In the event that it is desired to support the conventional GSM MS 20 using the MSC 22, a GSM RAN 30 is provided to link the GSM MS 20 with the MSC 22.

As further shown in FIG. 1, the IS-41 MSC 22 communicates with a roaming gateway, generally designated 32. The preferred roaming gateway 32 includes an IS-41 HLR 34 and a GSM visitor location register (VLR) 36 which cooperate with each other to permit the functionality described below. The roaming gateway 32 can also include or communicate with an IS-41 short message service center (SMSC) 38, for purposes to be shortly disclosed.

As set forth herein, the IS-41 MSC 22 uses the roaming gateway 32 to communicate with the GSM core infrastructure 14. The GSM core infrastructure 14 can include or can access a GSM authentication center 40 and a GSM home location register (HLR) 42 in accordance with GSM principles known in the art to authenticate subscriber mobile stations and to collect accounting and billing information as required by the particular GSM core infrastructure 14. Both the GSM core infrastructure 14 and the IS-14 core infrastructure 18 can communicate with a network such as a public switched telephone network (PSTN) and/or an Internet Protocol (IP) network.

In one non-limiting embodiment one or both of the CDMA-based MS 12, 16 are mobile telephones made by Kyocera, Samsung, or other manufacturer that use Code Division Multiple Access (CDMA) principles and CDMA over-the-air (OTA) communication air interfaces. The present invention, however, applies to other mobile stations such as laptop computers, wireless handsets or telephones, data transceivers, or paging and position determination receivers. The mobile stations can be hand-held or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as “users” and “mobiles” in some communication systems.

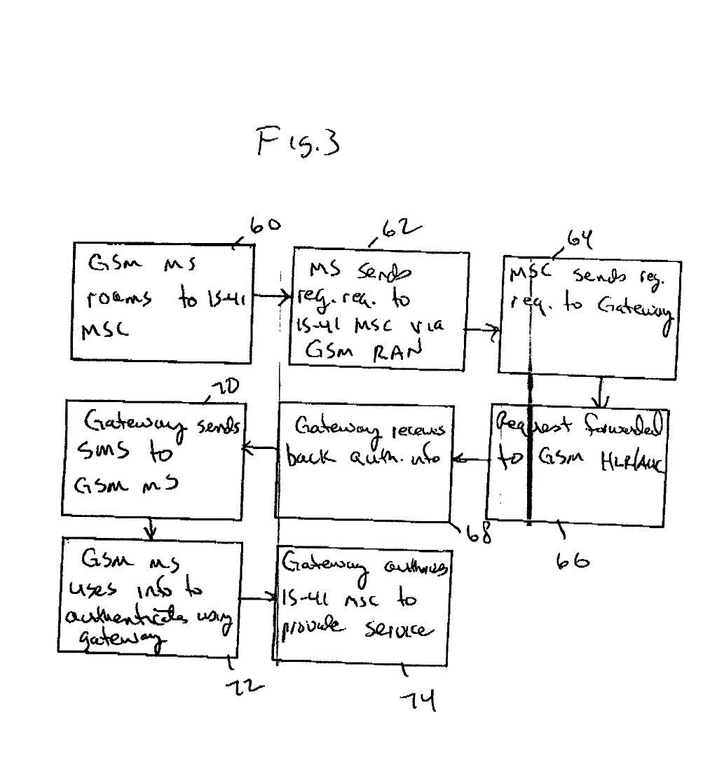

The logic of the system 10 for supporting the GSM-enabled CDMA MS 12 can be seen in reference to FIG. 2. Commencing at block 44, the MS 12 roams into the CDMA area. Moving to block 46, the MS 12 sends a message to the IS-41 MSC 22 using the CDMA RAN 24, with the message including an identification of the MS 12 such as an international mobile subscriber identifier (IMSI). The message sent by the MS can be, e.g., a location update message.

At decision diamond 48, the IS-41 MSC 22 determines, based on the IMSI, whether the MS 12 is a GSM subscriber. The MSC 22 can make this determination because the IMSI contains, among other information, a code representing the country and network in which the MS has a subscription. In the event that the CDMA-subscribing MS 16 is the MS under test, the logic would flow from decision diamond 48 to block 50, wherein the MS is authenticated using IS-41 principles by the IS-41 core infrastructure 18, using the IS-41 AUC 26 and ELR 28.

Assume, however, that the GSM-subscribed CDMA MS 12 has sent a location update message, so that the logic flows from decision diamond 48 to block 52. At block 52, the IS-41 MSC 22 accesses the roaming gateway 32 by sending it an authorization request along with the IMSI of the MS 12. In turn, the roaming gateway 32 accesses the GSM core infrastructure 14 and obtains necessary authentication information from the GSM AUC 40 and GSM HLR 42.

The authentication information in turn is relayed in a short message service (SMS) by the SMSC 38 to the MS 12 at block 54, essentially as a registration challenge. At block 56, by way of response the SIM 12a of the MS 12 sends back a SMS registration request to the MSC 22, which forwards the request to the roaming gateway 32. The request is used by the roaming gateway HLR 34 to determine whether the MS 12 has been authenticated as a subscriber in the GSM core infrastructure 14 in accordance with GSM authentication procedures. Assuming authentication is successful, at block 58 the roaming gateway 32 informs the IS-41 MSC 22 to provide service to the MS 12 by sending the MSC 22 a location message that functions as a registration response. In this way, the MS 12 essentially is registered with the IS-41 MSC 22 that is associated with the CDMA core infrastructure 18.

FIG. 3 shows the logic that is followed in the event that it is desired to support a conventional GSM MS 20 using a GSM RAN 30 to access the IS-41 MSC 22. Commencing at block 60, the GSM MS 20 roams to the IS-41 area and at block 62 sends a registration request to the IS-41 MSC 22 over the GSM RAN 30. Proceeding to block 64 the MSC 22 sends the registration request to the roaming gateway 32. At block 66 the roaming gateway 32 forwards the request to the GSM core infrastructure 14, which uses the GSM AUC 40 and HLR 42 to access authentication information and send the information back to the roaming gateway 32 at block 68.

Moving to block 70, the roaming gateway 32 sends the necessary authentication information to the GSM MS 20 using SMS generated by the SMSC 38. In turn, the GSM MS 20, at block 72, uses the information to authenticate itself to the gateway 32. The gateway 32 performs authentication and if successful, i.e., if the gateway 32 determines that the GSM MS 20 is properly subscribed in the GSM core infrastructure 14, the gateway 32 authorizes the IS-41 MSC 22 to provide service to the MS 20 at block 74.

While the particular METHOD AND SYSTEM FOR GSM MOBILE STATION ROAMING TO IS-41 as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

1. A roaming gateway configured for supporting communication between a CDMA mobile switching center (MSC) and a GSM core infrastructure to enable a mobile station (MS) subscribed in the GSM core infrastructure to communicate using the CDMA MSC, comprising: at least one register communicating with the GSM core infrastructure and with the MSC to convey authentication information from the GSM core infrastructure to the MS and to signal to the MSC to provide service to the MS.

2. The roaming gateway of claim 1, comprising an IS-41 home location register.

3. The roaming gateway of claim 2, comprising a GSM visitor location register.

4. The roaming gateway of claim 2, comprising a short message service center (SMSC).

5. The roaming gateway of claim 4, wherein the SMSC sends the authentication information to the MS using a short message service (SMS).

6. The roaming gateway of claim 1, wherein the gateway receives a location message from the MS.

7. The gateway of claim 6, wherein the gateway uses an identifier in the location message to obtain the authentication information.

8. A method for authenticating an MS subscribing in a first wireless system and roaming into a second wireless system, comprising:
receiving location information from the MS;
determining whether the MS is subscribed in the first system or second system; and
if the MS is subscribed in the first system, registering the MS in the second system.

9. The method of claim 8, wherein the location information includes at least one identifier associated with the MS.

10. The method of claim 9, wherein the identifier is an international mobile subscriber identifier (IMSI).

11. The method of claim 8, comprising sending from the second system to the first system a registration request in response to the location information.

12. The method of claim 11, comprising providing authentication information from the first system to the MS in response to the registration request.

13. The method of claim 8, wherein the first system is a GSM system and the second system is a CDMA system.

14. A system for servicing, using an IS-41 MSC, a cdma2000-1x or cdma2000-3x MS having a subscription in a GSM core infrastructure but not having a subscription in a CDMA core infrastructure associated with the IS-41 MSC, comprising:
an IS-41 MSC;
a CDMA RAN linking the MS with the IS-41 MSC;
a roaming gateway communicating with the IS-41 MSC; and
a GSM core infrastructure communicating with the roaming gateway.

15. The system of claim 14, wherein the MS sends a location update to the MSC and the MSC in turn communicates at least an identifier associated with the MS to the gateway.

16. The system of claim 15, wherein the gateway obtains authentication information from the GSM core infrastructure and sends the information to the MS using the MSC.

17. The system of claim 16, wherein the information is sent using a SMS.

18. The system of claim 17, wherein the MS responds to the SMS by authenticating itself to the gateway.

19. The system of claim 18, wherein the gateway informs the MSC to serve the MS if authentication is successful.

20. The system of claim 14, further comprising a GSM RAN communicating with the MSC.
